(19) United States
(12) Patent Application Publication
(10) Pub. No.: US 2009/0267844 A1
(43) Pub. Date: Oct. 29, 2009

(54) WIDEBAND AND DUAL-BAND N-ORDER MONOPOLE ANTENNA AND PRINTED CIRCUIT BOARD THEREOF

(75) Inventor: JUNN YI LIN, Hsinchu County (TW)

Correspondence Address: WPAT, PC;INTELLECTUAL PROPERTY ATTORNEYS, 2030 MAIN STREET, SUITE 1300, IRVINE, CA, 92614, US

(73) Assignee: RALINK TECHNOLOGY CORPORATION, HSINCHU COUNTY (TW)

(21) Appl. No.: 12/271,263

(22) Filed: Nov. 14, 2008

(30) Foreign Application Priority Data
Apr. 23, 2008 (TW) 097114789

(51) Int. Cl. H01Q 1/38; H01Q 1/24

(52) U.S. Cl. 343/702; 343/700 MS

(57) ABSTRACT

A wideband and dual-band n-order monopole antenna comprises an antenna body, a 5 GHz band matching branch, a 5 GHz band first-order branch, a 5 GHz band second-order branch, a 2.4 GHz band branch and a 2.4 GHz band matching branch. The antenna body is shaped substantially like an inverted “L,” including a first side and a second side, wherein the first side is substantially perpendicular to the second side. The 5 GHz band matching branch extends from the first side. The 5 GHz band first-order branch extends from the first side and in parallel to the 5 GHz band matching branch. The 5 GHz band second-order branch extends from the second side and is perpendicular to the 5 GHz band first-order branch. The 2.4 GHz band branch is connected to the second side through an extending arm, the combination of the extending arm and the 2.4 GHz band branch being shaped substantially like an “L.” The 2.4 GHz band matching branch extends outward from the second side.

### BACKGROUND OF THE INVENTION

1. Field of the Invention

The present invention relates to a dual-band monopole antenna, and more particularly, to a wideband and dual-band n-order monopole antenna used in a printed circuit board.

2. Description of the Related Art

With rapidly growing demand for wireless connections among consumer products and portable computers, a highly-integral and low-cost USB interface solution is the most popular in the Wi-Fi market. In order to comply with the rule of 802.11a/b/g/n, the design for bandwidth must provide a low-frequency range of 2.4 GHz to 2.5 GHz and a high-frequency range of 5.15 GHz to 5.85 GHz. However, the current Universal Serial Bus (USB) antenna exhibits disadvantages of small bandwidth, susceptibility to environmental change and transmitting difficulty due to variations of impedance in the air. Due to size limitations, it is not easy to accommodate two antennas in a USB circuit board.

In addition, the signals are susceptible to outside noises in the 5 GHz high-frequency band, and USB products are used in different environments, e.g., on or near a variety of solid objects that could affect transmission or receiving capabilities of the USB antenna. Good design, therefore, is necessary for reliable use.

Furthermore, many dual band antennas applied in small-scaled USB products primarily use chip antennas or external antennas due to technical limitations. However, the chip antenna exhibits a poor yield and external antennas increase cost.

Therefore, there is a need for technology enabling placement of two antennas within a limited space of a USB circuit board but still providing sufficient bandwidth at low cost.

### SUMMARY OF THE INVENTION

The wideband and dual-band n-order monopole antenna in accordance with one embodiment of the present invention comprises an antenna body, a 5 GHz band matching branch, a 5 GHz band first-order branch, a 5 GHz band second-order branch, a 2.4 GHz band branch and a 2.4 GHz band matching branch. The antenna body is shaped substantially like an inverted “L,” including a first side and a second side that are substantially perpendicular to each other. The 5 GHz band matching branch extends from the first side. The 5 GHz band first-order branch extends from the first side and is parallel to the 5 GHz band matching branch. The 5 GHz band second-order branch extends from the second side and is perpendicular to the 5 GHz band first-order branch. The 2.4 GHz band branch is connected to the second side through an extending arm, the combination of the extending arm and the 2.4 GHz band branch being shaped substantially like an “L.” The 2.4 GHz band matching branch extends outward from the second side.

The printed circuit board in accordance with one embodiment of the present invention comprises a front side and a reverse side. The front side has a corner on which a layout of a first wideband and dual-band n-order monopole antenna is situated. The reverse side has a corner on which a layout of a second wideband and dual-band n-order monopole antenna is situated. The first and second wideband and dual-band n-order monopole antennas are situated on different positions of the front side and reverse side, and the directions of feed-in currents flowing through the first and second wideband and dual-band n-order monopole antennas are opposite.

### BRIEF DESCRIPTION OF THE DRAWINGS

The invention will be described according to the appended drawings in which:

FIG. 1 shows a wideband and dual-band n-order monopole antenna in accordance with an embodiment of the present invention;

FIG. 2 shows a wideband and dual-band n-order monopole antenna installed on the front side and reverse side of a printed circuit board in accordance with another embodiment of the present invention;

FIG. 3 shows a frequency response diagram;

FIG. 4 shows a Smith chart of the embodiment;

FIG. 5 shows a 2.45 GHz XY E-Plane radiation pattern of the embodiment;

FIG. 6 shows a 2.45 GHz XY H-Plane radiation pattern of the embodiment;

FIG. 7 shows a 5.5 GHz YZ E-Plane radiation pattern of the embodiment; and

FIG. 8 shows a 5.5 GHz YZ H-Plane radiation pattern of the embodiment.

### PREFERRED EMBODIMENT OF THE PRESENT INVENTION

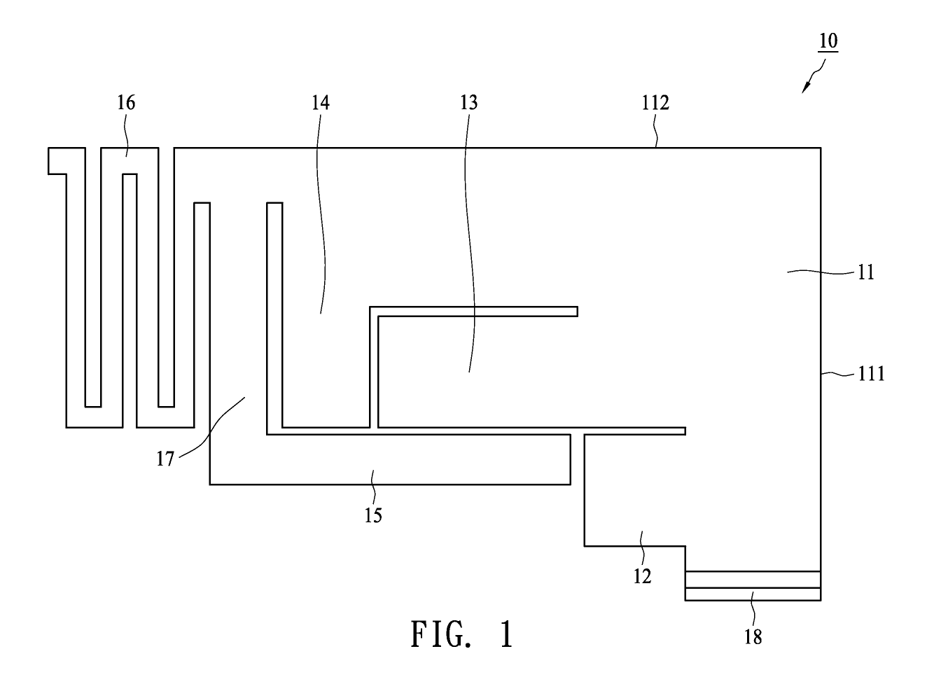

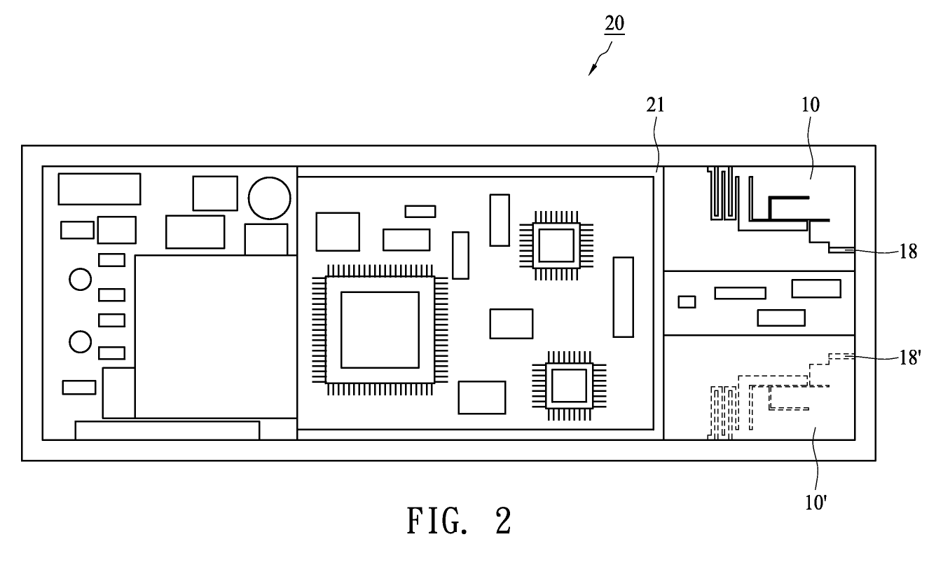

FIG. 1 shows a wideband and dual-band n-order monopole antenna in accordance with an embodiment of the present invention. The wideband and dual-band n-order monopole antenna 10 includes an antenna body 11, a 5 GHz band matching branch 12, a 5 GHz band first order branch 13, a 5 GHz band second order branch 14, a 2.4 GHz band branch 15 and a 2.4 GHz band matching branch 16. Generally, the size of the wideband and dual-band n-order monopole antenna 10 is equal to or smaller than 7 mm×13 mm; therefore, it is suitable to the trend of small-scaled design. The antenna body 11 is shaped like an inverted “L,” and includes a first side 111 and a second side 112. The 5 GHz band matching branch 12 extends inwardly from the bottom of the first side 111. The 5 GHz band first-order branch 13 extends inwardly from the middle of the first side 111 and substantially in parallel to the 5 GHz band matching branch 12. The 5 GHz band second order branch 14 extends inwardly from the bottom of the second side 112, and next to and perpendicular to the 5 GHz band first-order branch 13. The 2.4 GHz band branch 15 extends from the end of the second side 112 through an extension arm 17, and the combination of the extension arm 17 and the 2.4 GHz band branch 15 is shaped like an “L.” The 5 GHz band matching branch 12 faces the 2.4 GHz band branch 15, and both elements have opposite current flowing directions so that their electrical field will not interfere with one another. The 2.4 GHz band matching branch 16 extends outwardly from the second side 112. Because the current of the second side 112 is small and close to the grounding wire 21, as shown in FIG. 2, the 2.4 GHz band matching branch 16 can use two 180-degree curved wires. In addition, the feed-in point 18 could be selectively situated at the first side 111.

FIG. 2 shows a wideband and dual-band n-order monopole antenna installed on the front side and reverse side of a printed circuit board in accordance with another embodiment of the present invention. In order to comply with two-band demand of 802.11a/b/g/n, to provide Multi-Input, Multi-Output (MIMO) function as well as increase transmission speed and address the antenna isolation issue, two wideband and dual-band n-order monopole antennas 10 and 10′ are installed on different corners of the front side and reverse side of the printed circuit board 20, and the directions of the current flowing through the feed-in points 18 and 18′ of the front side and reverse side, respectively, are opposite and in parallel. A grounding wire 21 is situated on one side of wideband and dual-band n-order monopole antenna 10 so as to reduce the interference by other components on the printed circuit board 20.

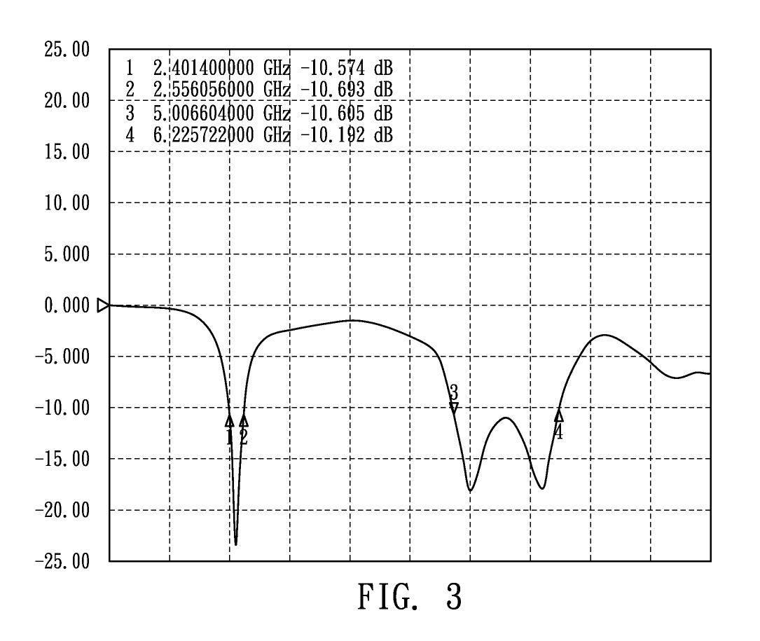

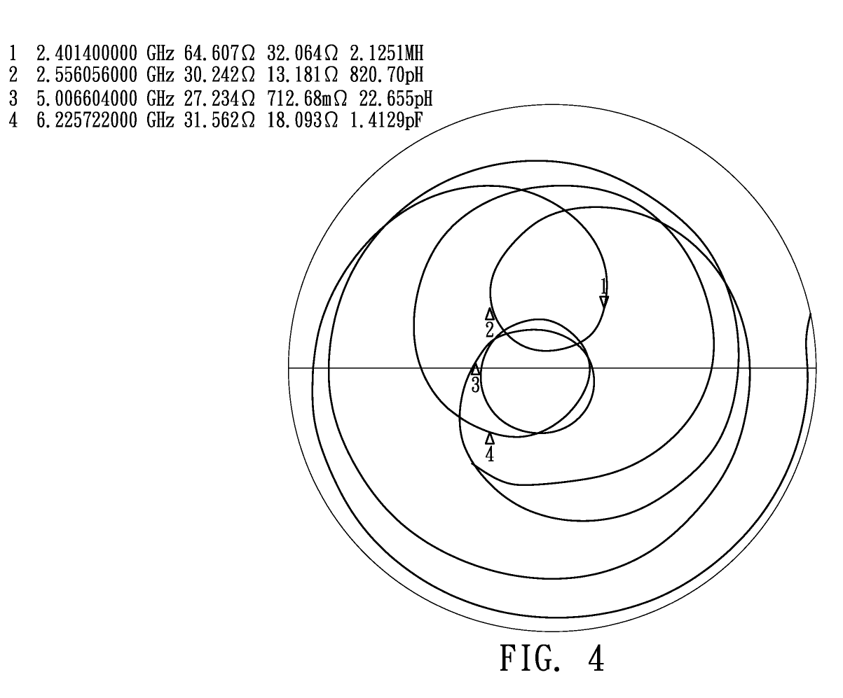

Table 1 shows a bandwidth range, FIG. 3 shows a frequency response diagram, and FIG. 4 shows a Smith chart of the embodiment.

TABLE 1

| Antenna type | Start | Stop | Bandwidth |
|---|---|---|---|
| 2.4 GHz Band | 2401 MHz | 2556 MHz | 155 MHz |
| 5 GHz Band | 5006 MHz | 6225 MHz | 1219 MHz |

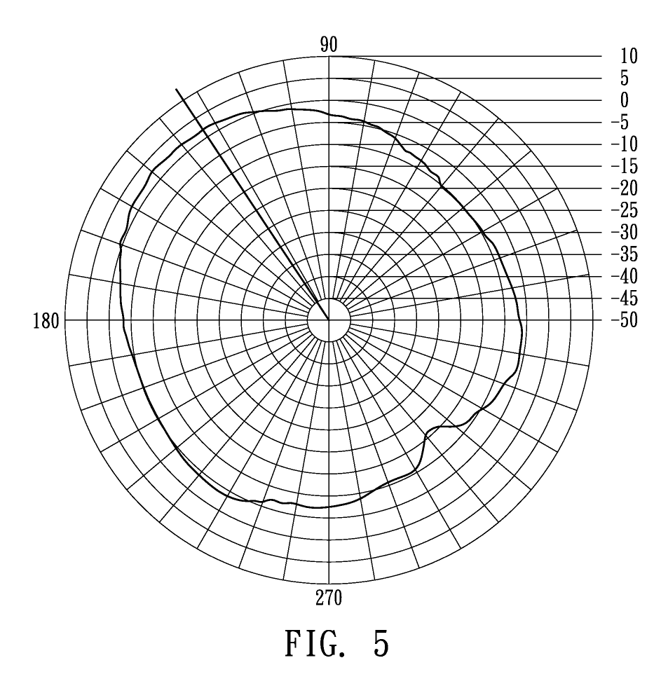

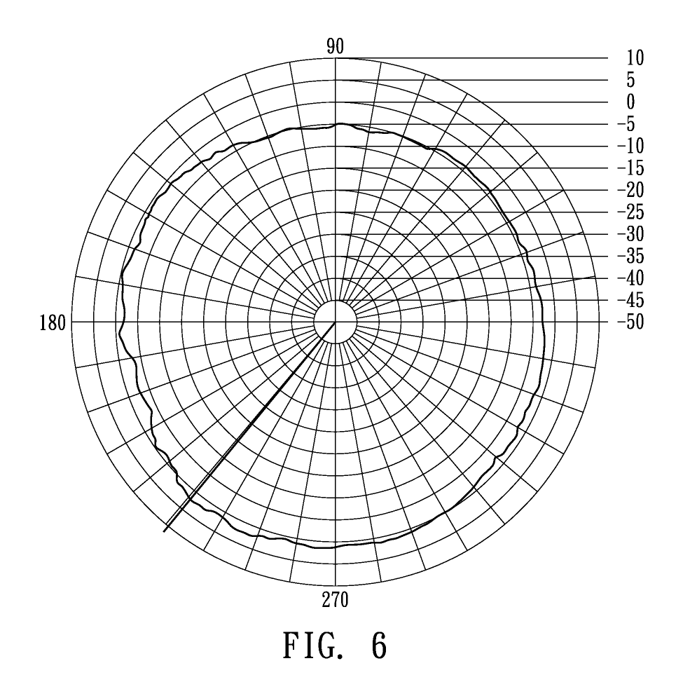

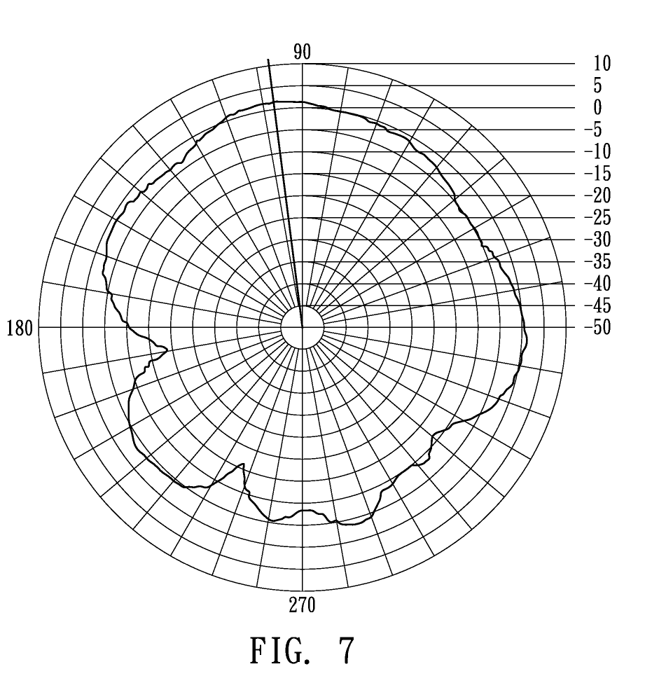

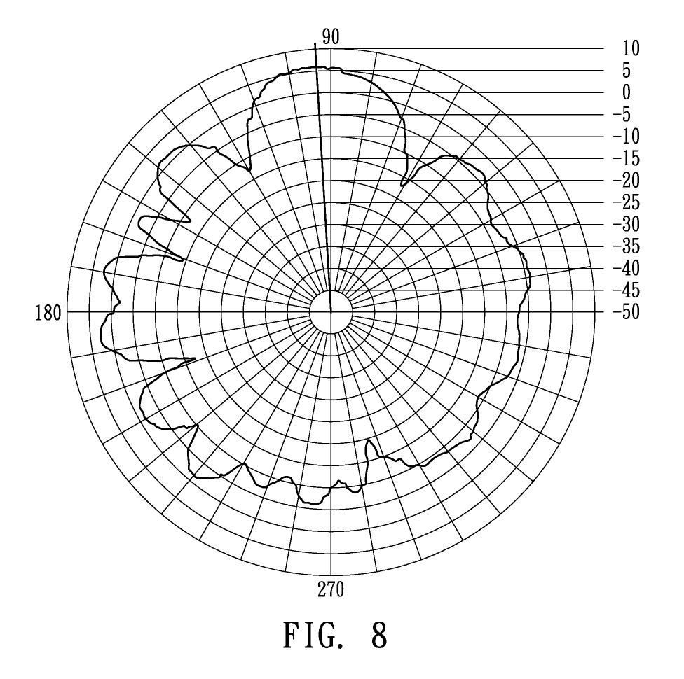

Table 2 shows the gain of the antenna radiation pattern, FIG. 5 shows a 2.45 GHz XY E-Plane radiation pattern, FIG. 6 shows a 2.45 GHz XY H-Plane radiation pattern, FIG. 7 shows a 5.5 GHz YZ E-Plane radiation pattern, and FIG. 8 shows a 5.5 GHz YZ H-Plane radiation pattern. It is easily seen that the wideband and dual-band n-order monopole antenna 10 of the present invention is of a direction-wide radiation pattern.

TABLE 2

| | XY-HOR | YZ-VER |
|---|---|---|
| 2.45 GHz | 2.50 dBi | 2.67 dBi |
| 5.5 GHz | 2.10 dBi | 6.44 dBi |

The wideband and dual-band n-order monopole antenna 10 uses a multi-order idea to implement a greater bandwidth so as to retain stability and high performance. As to the scale issue, the present invention simplifies the width and length of the antenna, having an advantage of high density so as to effectively utilize the limited space of the circuit board. For example, a USB circuit board with size equal to or smaller than 20 mm×60 mm is used to implement the embodiments of the present invention. There is no extra cost because the antenna is printed on the circuit board.

The bandwidths of the embodiment of the present invention are between about 2.37 GHz to 2.51 GHz and about 4.9 GHz to 6.1 GHz, representing a significant increase over prior arts. The present invention also has an advantage of high gain, e.g., the gain of the XY-E Plane in the 2.4 G band is 2.5 dBi, the gain of the YZ-H Plane in the 2.4 G band is 2.67 dBi, the gain of the XY-E Plane in the 5 G band is 2.10 dBi, and the gain of the YZ-H Plane in the 5 G band is 6.44 dBi, which are all above the gain of prior art.

The above-described embodiments of the present invention are intended to be illustrative only. Numerous alternative embodiments may be devised by persons skilled in the art without departing from the scope of the following claims.

What is claimed is:

1. A wideband and dual-band n-order monopole antenna, comprising:
an antenna body including a first side and a second side, wherein the first side is substantially perpendicular to the second side;
a 5 GHz band matching branch extending from the first side;
a 5 GHz band first-order branch extending from the first side and in parallel to the 5 GHz band matching branch;
a 5 GHz band second-order branch extending from the second side and being perpendicular to the 5 GHz band first-order branch;
a 2.4 GHz band branch connected to the second side through an extending arm, the combination of the extending arm and the 2.4 GHz band branch being shaped substantially like an “L”; and
a 2.4 GHz band matching branch extending outward from the second side.

2. The wideband and dual-band n-order monopole antenna of claim 1, wherein the 2.4 GHz band matching branch has at least two 180-degree curved wires.

3. The wideband and dual-band n-order monopole antenna of claim 1, wherein the 5 GHz band first-order branch is disposed above the 5 GHz band matching branch.

4. The wideband and dual-band n-order monopole antenna of claim 1, wherein the 2.4 GHz band branch is disposed between the 5 GHz band second-order branch and the 2.4 GHz band matching branch.

5. The wideband and dual-band n-order monopole antenna of claim 1, wherein the 5 GHz band second-order branch is immediately next to the 5 GHz band first-order branch, but not immediately next to the 5 GHz band matching branch.

6. The wideband and dual-band n-order monopole antenna of claim 1, wherein the printed circuit board is a universal serial bus (USB) circuit board, and the size of the USB circuit board is equal to or smaller than 20 mm×60 mm.

7. The wideband and dual-band n-order monopole antenna of claim 1, whose size is smaller than 7 mm×13 mm.

8. The wideband and dual-band n-order monopole antenna of claim 1, further comprising a feed-in point which is situated on the first side.

9. The wideband and dual-band n-order monopole antenna of claim 1, wherein the 5 GHz band matching branch faces the 2.4 GHz band branch, and the directions of the currents flowing through the 5 GHz band matching branch and the 2.4 GHz band branch are opposite.

10. The wideband and dual-band n-order monopole antenna of claim 1, wherein the 5 GHz band matching branch, 5 GHz band first-order branch, 5 GHz band second-order branch and 2.4 GHz band branch extend inwardly.

11. A printed circuit board comprising:
a front side having a corner on which a layout of a first wideband and dual-band n-order monopole antenna is situated; and
a reverse side having a corner on which a layout of a second wideband and dual-band n-order monopole antenna is situated;
wherein the first and second wideband and dual-band n-order monopole antennas are situated in different positions of the front side and reverse side, and the directions of feed-in currents flowing through the first and second wideband and dual-band n-order monopole antennas are opposite.

12. The printed circuit board of claim 11, wherein the first and second wideband and dual-band n-order monopole antennas are wideband and dual-band n-order monopole antennas in accordance with claim 8.

13. The printed circuit board of claim 11, further comprising a grounding wire used to reduce noise interference by cooperating with the first and second wideband and dual-band n-order monopole antennas.

14. The printed circuit board of claim 11, wherein the printed circuit board is a USB circuit board, and the size of the USB circuit board is equal to or smaller than 20 mm×60 mm.

15. The printed circuit board of claim 11, wherein the size of the first and second wideband and dual-band n-order monopole antennas is equal to or smaller than 7 mm×13 mm.
